(19) United States
(12) Patent Application Publication
(10) Pub. No.: US 2024/0046280 A1
(43) Pub. Date: Feb. 8, 2024

(54) METHOD AND SYSTEM FOR CARBON ACCOUNTING UTILIZING BLOCKCHAIN TECHNOLOGY

(71) Applicant: Empower Energy Technology L.L.C., Atlanta, GA (US)

(72) Inventors: Mark Bell, Atlanta, GA (US); Thatcher Young, Marietta, GA (US); John Scarborough, Salt Springs, FL (US)

(21) Appl. No.: 18/231,738

(22) Filed: Aug. 8, 2023

Related U.S. Application Data
(60) Provisional application No. 63/395,888, filed on Aug. 8, 2022.

(51) Int. Cl. G06Q 30/018

(52) U.S. Cl. CPC G06Q 30/018; G06Q 2220/00

(57) ABSTRACT

A carbon accounting system including a data receiving arrangement configured to receive energy data from an energy data collection apparatus; a data aggregation processor configured to aggregate the energy data with other energy data to form aggregated energy data; and a data communicator configured to transfer the aggregated energy data to a blockchain platform. The blockchain platform is configured to share the aggregated energy data and perform carbon accounting on a blockchain. Carbon emissions may be calculated and the energy data may be collected in real-time. The energy data collection apparatus may include a smart meter. The blockchain platform may be configured to automatically convert Renewable Energy Credits (RECs) into Non-Fungible Tokens (NFTs). An exemplary method of accounting for carbon emissions is provided.

### CROSS-REFERENCE TO RELATED APPLICATIONS

The present application claims priority to U.S. Provisional Patent Application No. 63/395,888 filed on Aug. 8, 2022, entitled “Method and System for Carbon Accounting Utilizing Blockchain Technology”, which is incorporated by reference in its entirety.

### BACKGROUND OF THE INVENTION

### 1. Field of the Invention

The invention relates to the use and delivery of active ingredients to prevent premature activation, and in particular to methods and systems for application of active ingredients without premature activation.

### 2. Description of the Related Art

Carbon accounting (also known as carbon or greenhouse gas inventory) generally refers to processes used to measure or quantify how much carbon dioxide equivalents an organization emits, which is then used to understand the organization's climate impact and make carbon-related decisions. However, current carbon accounting is insufficient in a hyper-transparent world, since it exists mainly as “data” on spreadsheets; lacks provability, trustworthiness, and traceability; and can facilitate “Greenwashing”. While carbon accounting is aimed at providing an accurate sustainability measurement, there are a myriad of problems associated with current methods for calculating carbon emissions.

First, current methods for collecting environment data are cumbersome and error prone. That is, some companies rely on teams of analysts manually compiling massive spreadsheets of environmental data. However, this manual process leads to significant risk of improper calculations, mis-assignment of attributes to multiple projects and potential double-counting of Renewable Energy Credits (RECs). Furthermore, since this data is not collected in any sort of trusted and verifiable manner or format, it can be manipulated or subject to unwarranted changes. As a result, tracking environmental data or information lacks a high degree of trustworthiness or traceability.

In addition, while many corporations, institutions, and governments have made commitments to “reducing their carbon footprint” and/or achieving “carbon neutrality”, current methods for measuring carbon emissions do not secure environmental data in a trusted manner for subsequent verification. That is, companies create their own methodologies for carbon accounting and black box them. As a result, there is no transparency as to the trustworthiness of accounts of carbon emissions.

To compound the problem, third party certificate organizations that offer auditing services provide little help in proving that environmental data has been collected in a trusted and verifiable manner. That is, most of these third party companies hedge their analysis with a disclaimer to the accuracy of their review (based on the quality of customer supplied data) and use manual auditing of other human generated data streams, which are error prone and allow for mistakes.

Furthermore. Renewable Energy Credits (RECs) are difficult to value and consequently suffer from reduced access to markets. RECs represent the environmental attributes (carbon reduction/elimination) of renewable energy projects, for example solar energy projects, and are difficult to measure without significant, manual, human interaction. This manual process leads to significant risk of improper calculations, mis-assignment of attributes to multiple projects and potential double-counting of RECs. Because these attributes only have limited market value at this time, very little scrutiny has been given to their calculation and tracking. Additionally, many corporations, institutions and governments have made commitments to “reducing their carbon footprint, and/or achieving “carbon neutrality” which will require a much more detailed and rigorous accounting than is being conducted in the above current state. There are 3rd-party certification organizations that provide auditing such as Green-e, but this is still the manual auditing of other human-generated data streams, which leaves room for mistakes. Most of these 3rd-party companies qualify their analysis with a disclaimer as to the accuracy of their review being based on the quality of customer supplied data.

Additionality is a concept within carbon accounting and management that holds that for RECs generated from a Renewable Energy Project to be consider unique and additive, they must be proven to be additional. In other words, these RECs should not be claimed by anyone else, and are due to the creation of new carbon sequestration or elimination. GHG reductions are additional if they would not have occurred in the absence of a market for offset credits. If the reductions would have happened anyway—i.e., without any prospect for project owners to sell carbon offset credits, then they are not additional.

Therefore, there is currently a gap in the US carbon accounting market for accurate, immutable carbon accounting software solutions. This is leading to dubious claims by corporations, institutions and governments regarding their carbon neutrality due to a lack of transparency and uncorruptible carbon/REC data.

With little standardization, there is a need for companies that can feed real-time energy data into a carbon accounting blockchain platform.

### SUMMARY OF THE INVENTION

The present technology provides a system that collects real-time energy data (that is highly accurate), aggregates the energy data in a standard and trusted way, transfers the data to a blockchain platform that facilitates sharing of data and accurate carbon accounting, and converts RECs into Non-Fungible Tokens (NFTs) without manual data entry or human interaction.

An exemplary embodiment of the present technology provides a carbon accounting system. The exemplary system includes a data receiving arrangement configured to receive energy data from an energy data collection apparatus. The exemplary system also includes a data aggregation processor configured to aggregate the energy data with other energy data to form aggregated energy data. The system further includes a data communicator configured to transfer the aggregated energy data to a blockchain platform. The blockchain platform is configured to share the aggregated energy data and perform carbon accounting on a blockchain.

The carbon accounting may include calculating carbon emissions. The energy data collection apparatus may be configured to collect the energy data in real-time. The energy data collection apparatus may include a smart meter. The blockchain platform may be configured to automatically convert Renewable Energy Credits (RECs) into Non-Fungible Tokens (NFTs). The aggregated energy data may be formatted in a standardized form.

An exemplary method of accounting for carbon emissions according to the present technology includes receiving energy data from an energy data collection apparatus. The exemplary method also includes aggregating, using a data aggregation processor, the energy data with other energy data to form aggregated energy data. The exemplary method further includes transferring the aggregated energy data to a blockchain platform. The blockchain platform may be configured to share the aggregated energy data. The exemplary method also includes performing carbon accounting on a blockchain.

### BRIEF DESCRIPTION OF THE DRAWINGS

The invention is described in more detail with reference to the accompanying drawings, in which only preferred embodiments are shown by way of example. In the drawings:

FIG. 1 includes a schematic diagram of an exemplary architecture of a system according to an exemplary embodiment of the present invention.

FIG. 2 includes a schematic diagram of another exemplary architecture of a system according to an exemplary embodiment of the present invention.

FIG. 3 is a flow chart illustrating an exemplary method according to the present invention.

FIG. 4 is a schematic diagram of a system according to an exemplary embodiment of the present invention.

FIG. 5 is a schematic diagram of a computing system used in an exemplary embodiment of the present invention.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

An exemplary embodiment of the present technology provides a blockchain based, trustworthy, carbon accounting platform that utilizes IoT (Internet of Things) energy meters (also referred to as smart meters) to collect energy data, and converts Renewable Energy Credits (RECs) into Non-Fungible Tokens (NFTs) without manual data entry or human interaction. Advantages of the present technology include: 1) transferring energy data in a standard and trusted way; 2) facilitating carbon accounting, generating/selling RECs, in an integrated system; 3) promoting sharing of data between different organizations; and 4) without requiring manual data entry of energy data or other human interaction.

Exemplary systems according to the present technology collect highly accurate energy data by reading meters frequently, for example every 1 minute, and then adding up these readings every 15 minutes. In this manner, the accuracy and credibility of the data is improved. In addition, exemplary systems according to the present technology create two NFTs (a USE NFT and a GEN NFT) periodically (i.e., when a milliwatt hour threshold is met).

Renewable Energy Certificates (typically referred to as “RECs”) represent the environmental attributes of 1 megawatt hour (MWh) of renewable energy generation on the electricity grid. RECs are used to track when and where renewable energy is generated, who it is sold to, and who is using it. After electrical power is introduced into an electrical grid, it not possible to trace power back from usage to generation.

In conventional energy systems, 90% of energy data goes into a database managed by utility companies or manufacturers of solar energy systems. The industry standard is that utility companies use meters that collect a single energy measurement in kilowatt-hours every 15 minutes.

One problem with conventional systems is inaccurate data due to the infrequent measurements. A single reading every 15 mins does not provide sufficiently granular data. A related problem with conventional systems is that RECs that are generated based on these energy measurements are also not very accurate due to the infrequent measurements.

Another problem with conventional systems is data integrity. There is no universal format for energy data, and it is easy to manipulate, change, and misrepresent energy data, unless you involve a third party energy certifier to check the energy data for accuracy.

Exemplary embodiments of the present technology include computer-implemented systems and methods to address these problems.

First, one or more IOT (Internet of Things) meters (associated with a home/business) are employed to collect raw meter data. Periodically or continuously, the IOT meter takes two readings of: 1) the energy that passes into a house/business called a USE reading, representing the amount of power being used by the house/business, and 2) the energy that passes to the outside of house/business called a GEN reading, representing the amount of power being created by the house/business.

In exemplary embodiments, the IOT meters collect a USE reading and GEN reading in Joules every minute. IOT meters also collect a time, date, and/or GPS location for each USE and GEN reading.

In contrast to conventional systems, in which meters take a reading every 15 mins, the present technology takes a USE and GEN reading every minute, and then sum it up every 15 minutes. Further in contrast to conventional systems, the present technology collects energy data in Joules, providing improved accuracy. In this way, the collected energy data is more granular and accurate.

According to the present technology, the IOT meters then push the USE and GEN readings to a blockchain platform, without human involvement. Every 15 mins: 1) the sum of the 15 USE readings (“USE sum”) are gathered in Joules and converted to KWh with formula of 1 J=1 KWh/3600000; 2) the sum of 15 GEN readings are gathered (“GEN sum”) in Joules and converted to KWh with formula of 1 J=1 KWH/3600000.

When the GEN sum reaches 1 megawatt hour, a resulting CarbonCredit Contract is created on the blockchain, where a REC NFT is generated and recorded. The Token Type in this transaction is GEN. Likewise, when the USE sum reaches 1 megawatt hour, a resulting CarbonCredit Contract is created on the blockchain, where a USE NFT is generated and recorded.

A UUID (Unique Identifier of the corresponding contract) is recorded on all meter readings that encompass the CarbonCredit Contract just created. This ensures the integrity of inputs/readings to one and only one CarbonCredit Contract.

Exemplary embodiments of the present technology provide various advantages, including processing done on the blockchain. For example, periodically (for example, daily, weekly, monthly, or any other time period), the system can compare the USE NFTs against the REC NFT's to determine carbon neutrality, with a 1:1 ratio indicating carbon neutral. In this way, REC NFTs can be used against energy balance and transferred.

An exemplary embodiment of the present technology provides for obtaining raw meter readings, for example from smart meters connected to the internet. Meters may be configured for a USE and a GEN setting to facilitate measurement of energy being used and/or generated. Therefore, a smart meter according to the present technology may indicate the number of joules, watts, kilowatt hours, or any other appropriate measure of energy and/or power, used or generated. Meter data may be filtered for meter readings on adjustable time criteria for intervals of data. In this manner, adjustable increments of data may be recorded on the blockchain, and may be modified in any manner. Meter readings conventionally represent a cumulative meter value from a point in time to another point in time. Missed readings are not an issue with conventional meters since cumulative values of use and generated power and/or electricity are determined.

According to exemplary embodiments of the present technology, meter data collection may be performed as a scheduled software process that periodically scrapes meter readings from smart meters that have not been previously transacted, and then executes a blockchain interaction. Meter data may be read and recorded directly to a blockchain via an exposed API, which may be at the customer level. The API may then execute a smart contract to record meter readings into the blockchain.

In alternative exemplary embodiments, a direct meter interface may be utilized. Meters may be configured to directly transact with the blockchain. Meters are configured with appropriate logic and customer keys to manage security and integrity of meter data

Sample meter reading data may include a unique identier assigned to at least one of the consumer, the location, and/or the meter. The data may also include a timestamp, geolocation data, a meter name, a consumer name or other identifier, and/or an amount of energy generated and/or used at the location.

Carbon emissions contracts, which may be used for both USE and GEN readings. A meter reading may be assigned to one and only one USE and GEN carbon credit contract. Analyzing meter data for determination of carbon emissions contracts, for both USE and GEN contracts, may be performed regularly, and may be created at 1000 KWH increments. A query may be run against meter data that determines all readings that are: 1) not assigned to an existing carbon emissions contract (note, a meter reading typically can only be applied to a single carbon credit contract of type USE and of type GEN; 2) filtered by organization; and 3) filtered by site/location. Further, meter readings can be sorted in various ways, including descending or ascending value. A measurement of KWH of outstanding readings may be determined by taking the difference of the last reading in time to the first reading of time to determine the net USE and/or GEN values (depending on which contract is being created). The net value (in JOULES) may be converted to KWH by formula: 1 J=1 KWh/3600000. If the KWH is greater and/or equal to 1000 KWH, a resulting carbon emissions contract may be created on the blockchain.

The carbon emissions contract represents a relational association for a grouping of individual meter readings (USE or GEN). Each USE and GEN value is unique (and therefore can be an NFT) that can represents a data point from a specific source uniquely. This data point cannot be duplicated. The carbon contract being specified associates these unique data points to a contract that in itself is unique. This allows and guarantees that data points will not be duplicated, and also confirms that the data points that comprise the credits or value are represented in carbon contract that can be exchanged/sold/allocated uniquely to a specific customer. In order to prevent resale or re-use of such credits, this carbon contract will essentially represent the lifecycle of the carbon data, which prevents duplication or double accounting of such data. In this manner, the accuracy and legitimacy of the carbon credit data prevents fraud and/or duplication of such data.

A data record may include some or all of the following: a date of creation, a time stamp; a unique identifier; an amount of KWH; an organization identifier; a site identifer; a token type identifier, indicating whether the reading represents energy use (USE) or energy generation (GEN), a unique identifier of the corresponding contract. This information may be recorded on all meter readings that encompass the carbon emissions contract just created, thus ensuring the integrity of input/readings to one and only one carbon emissions contract.

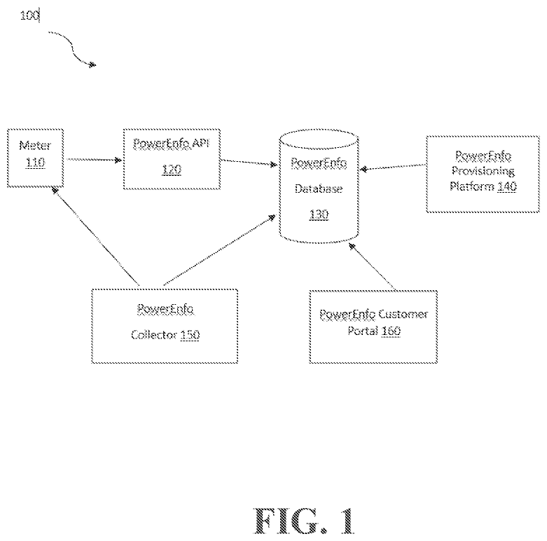

FIG. 1 includes a schematic diagram of an exemplary architecture of system 100 according to an exemplary embodiment of the present invention. In system 100, meter 110 (also referred to as an egauge metering system) receives instructions from PowerEnfo Collector 150. PowerEnfo Collector 150 may be a custom application that runs on a schedule to collect daily data sets from the egauge metering system. Meter 110 outputs data to PowerEnfo API 120. PowerEnfo API 120 may be a custom API to receive minute level inputs from meters (egauges). The configuration of inputs may be collected each minute, and a day's worth of data utilizing unix time format and seconds indicating length of data to pull may be collected in PowerEnfo DB 130, which may be a server or cloud-based database. PowerEnfo DB 130 may also receive data, information, and/or instructions from PowerEnfo Collector 150. PowerEnfo Provisioning Platform 140 may be coupled to PowerEnfo DB 130 and may include a customer level HTTP application for PowerEnfo setup and management. PowerEnfo Provisioning Platform 140 may enable custom functionality, specific company configurations, site configuration, and meter configuration. PowerEnfo Customer Portal 160 may be coupled to PowerEnfo DB 130 and may enable a customer to access data and/or may enable a customer to configure the meter 110 using a meter configuration interface.

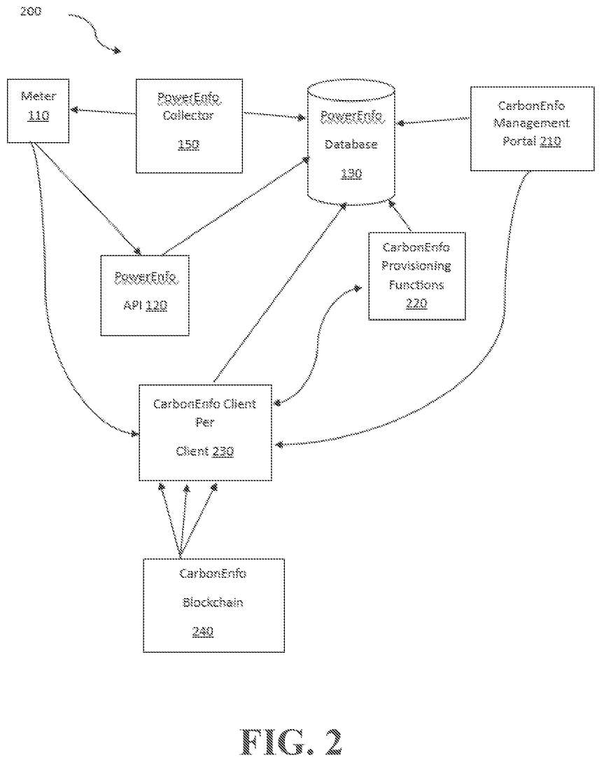

FIG. 2 includes a schematic diagram of another exemplary architecture of system 200 according to an exemplary embodiment of the present invention. In system 200, meter 110 receives instructions from PowerEnfo Collector 150. PowerEnfo Collector 150 may be a custom application that runs on a schedule to collect daily data sets from the egauge metering system. Meter 110 outputs data to PowerEnfo API 120. PowerEnfo API 120 may be a custom API to receive minute level inputs from meters (egauges). The configuration of inputs may be collected each minute, and a day's worth of data utilizing unix time format and seconds indicating length of data to pull may be collected in PowerEnfo DB 130, which may be a server or cloud-based database. PowerEnfo DB 130 may also receive data, information, and/or instructions from PowerEnfo Collector 150. PowerEnfo DB 130 may receive instructions from CarbonEnfo Management Portal 210 and from CarbonEnfo Provisioning Functions 220. CarbonEnfo Client Per Client 230 may receive data directly from meter 110 and may provide data PowerEnfo DB 130. CarbonEnfo Client Per Client 230 may also receive instructions from CarbonEnfo Management Portal 210 and may bilaterally communicate with CarbonEnfo Provisioning Functions 220. CarbonEnfo Client Per Client 230 may read and write to CarbonEnfo BlockChain 240 to enable the block chain platform to record carbon accounting data to enable the execution of smart carbon contracts according to the present technology.

PowerEnfo API 120 may be a standalone service outside of chaincode that is responsible for handling meter specific translations, data collection, data parsing, a blockchain interface, and pushing and pulling data. The API may include functional libraries used to enable various functions, including: meter data receiving/retrieving; receiving data from gauges (push or pull): meter data translation—translating pulled or pushed data based on the meter specific (possible library for meter parsing, executing any desired business rules; preparing the data for meter data saving meter data saving; executing a desired logic to interface with CarbonEnfo BlockChain 240; blockchain provisioning—wallets for meters will be done via additional functionality added to PowerEnfo configuration interface (i.e. wallet management) blockchain; transaction execution—run necessary logic to execute transactions, create, allocate, and query, necessary actions to query blockchain for reporting; and other functionality (i.e rec creation) reporting—interface for a standard set of CarbonEnfo operations. This interface then can be integrated into any appropriate application and/or device.

The exemplary system may also provide a customer portal interface, which enables the development of a plug-in to a customer portal which enables reporting and/or visualization. A configurator interface may further enable development of a plug-in to enable reporting and/or visualization.

System 200 may enable the functionality of a blockchain to manage assets to be applied to carbon emissions and carbon accounting. Chaincode execution is partitioned from transaction ordering, limiting the required levels of trust and verification across node types, and optimizing network scalability and performance. The immutable, shared ledger of the blockchain encodes the entire transaction history for each channel, and includes SQL-like query capability for efficient auditing and dispute resolution. Channels and private data collections enable private and confidential multi-lateral transactions that may be required by competing businesses and regulated industries that exchange assets on a common network. Permissioned membership provides a trusted blockchain network, where participants know that all transactions can be detected and traced by authorized regulators and auditors. A unique approach to consensus enables the flexibility and scalability needed for the enterprise. A CarbonEnfo token represents the ledger entries from metering data points that make up the transactions comprising the power generation and usage metrics. CarbonEnfo Tokens are created on the blockchain. Document properties may include: a meter identifier (unique UUID of meter); a meter name; a carbon token identifier; a site identifier; an organization identifier; a generated value, for example in Joules (watts/second); a used value, for example in Joules (watts/second); a date; a time stamp in a universal format, a GPS or raw position; a carbon credit contract identifier; a carbon credit offset contract identifier; and any other appropriate information.

A CarbonRec token comprises the allocation of CarbonEnfo tokens for an existing organization that are tallied in order to generate a “REC” (1000 KWH of power generation) Fields may include: RecID. Unique ID of the REC, OriginatingOrgID (Organization id owning the REC), SiteID (Site ID where the data is calculated from), CreatedDate (Date REC created), OwningOrgID (ID of the owning organization ID), KWH (number of KWH comprising the REC), and DocType: Use and Gen, and Transactions Types (ChainCode).

CarbonEnfo Tokens are assigned to a REC. At the execution of a smart contract, all unassigned CarbonEnfo tokens for an organization are determined and utilized to create a CarbonREC. There are two types of REC tokens. USE and GEN. Both USE and GEN CarbonRECS may be generated in 1000 KWH increments. CarbonRECS may be calculated and issued at site level (RECS at certain locations are potentially more valuable).

In order to adhere and uphold the integrity, security, and privacy of the blockchain, there are considerations around provisioning data collection for a new organization (customer). Each organization will participate as a participant in the CarbonEnfo BlockChain 240 (also referred to as CE-BC 240). It is important to consider the fact that each organization has secure elements that only the particular organization should manage in a trusted way. It is assumed that the controlling and originating organization will assist and establish each organization (customer) into the deployment of their specific CarbonEnfo ecosystem. The ecosystem can include basic to complex considerations. Initially, the most Basic setup is used to allow for customers to participate (which in one exemplary embodiment may be via DEFAULT settings in a blockchain). In order to participate, there are certain items that need to be accomplished.

Blockchain Setup—Configure and deploy the necessary CE-BC 240 elements, including: Peer Node, Certificate Authority, Application Key, and SmartContract Permissioning CarbonEnfo API Setup. A web service based application manages the secure interaction with the CE-BC 240 on the customers behalf. Each customer may maintain a proprietary application, for instance a web service/app deployed on customer servers.

JSON data set may be used to provide data points to enable a chart/graph of the granular data. A JSON Query may be used on the client to summarize and parse data. All records are identified (each token) in order to execute a smart contract that will set the contract ID of each token record to the contractID of the CarbonCredit Token Created (this enables the creation of CarbonCredit tokens, that will ultimately be the thing of value in the long term). JSON data provides a reporting capability. The JSON data is a data set that returns all the corresponding related data for a meter, or a customer (or whatever level desired) on all the use/gen values that ultimately form the carbon credit. The exemplary system provides the ability to pull data based on a customer ID, a device ID, and/or contract requirements, which enables comprehensive reporting.

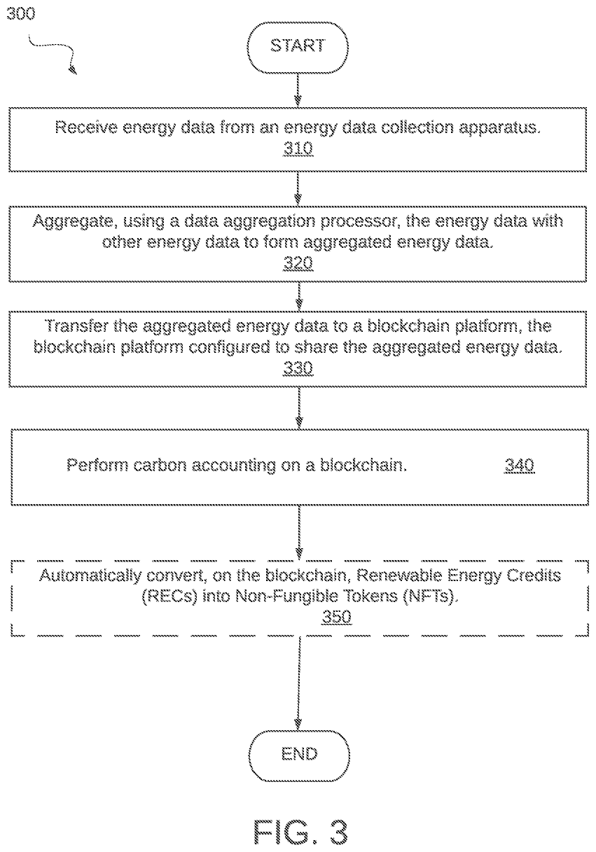

FIG. 3 is a flow chart illustrating exemplary method 300 according to the present invention. Method 300 starts in the start oval and proceeds to operation 310, which indicates to receive energy data from an energy data collection apparatus. From operation 310, the flow in method 300 proceeds to operation 320, which indicates to aggregate, using a data aggregation processor, the energy data with other energy data to form aggregated energy data. From operation 30, the flow proceeds to operation 330, which indicates to transfer the aggregated energy data to a blockchain platform. The blockchain platform is configured to share the aggregated energy data. From operation 330, the flow proceeds to operation 340, which indicates to perform carbon accounting on a blockchain. From operation 340, the flow in method 300 proceeds to optional operation 350, which indicates to automatically convert, on the blockchain, Renewable Energy Credits (RECs) into Non-Fungible Tokens (NFTs). From optional operation 350, the flow in method proceeds to the end oval.

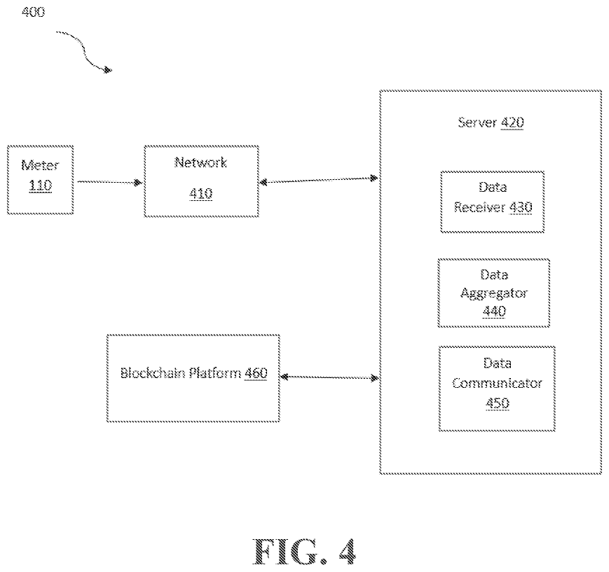

FIG. 4 is a schematic diagram of system 400 according to an exemplary embodiment of the present invention. In system 400, meter 110 is bilaterally coupled for communication to and from network 410. Network 410 may be the internet, a private network, or any other appropriate network. Communication in system 400 may be wireless or wired. Network 410 may bilaterally communicate with a data receiver arrangement 430 in server 420. Server 420 may also include data aggregator 440 adapted to aggregate data from meter 110 as well as additional meters, as described herein. Server 420 may also include data communicator 450, which may receive aggregated data from data aggregator 440 and communicate it to blockchain platform 460. Blockchain platform 460 may comprise a network of computers operating a public ledger of carbon accounting data, which may be accessible publically or to members of a private network.

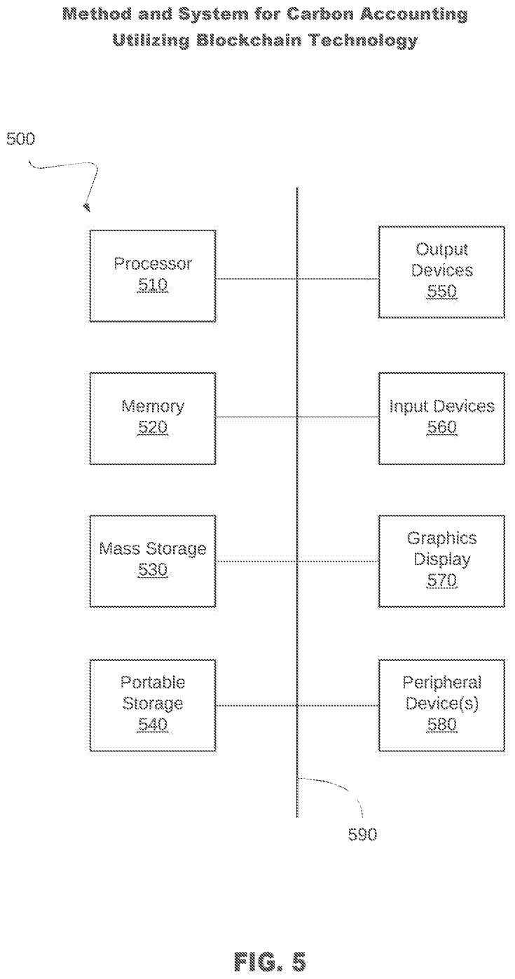

FIG. 5 is a schematic diagram of computing system used in an exemplary embodiment of the present invention. FIG. 5 illustrates exemplary computing system 500, hereinafter system 500, that may be used to implement embodiments of the present invention. The system 500 may be implemented in the contexts of the likes of computing systems, networks, servers, or combinations thereof. The system 500 may include one or more processors 510 and memory 520. Memory 520 stores, in part, instructions and data for execution by processor 510. Memory 520 may store the executable code when in operation. The system 500 may further includes a mass storage device 530, portable storage device(s) 540, output devices 550, user input devices 560, a graphics display 570, and peripheral device(s) 580.

The components shown in FIGURE S are depicted as being connected via a single bus 590. The components may be connected through one or more data transport means. Processor 510 and memory 520 may be connected via a local microprocessor bus, and the mass storage device 530, peripheral device(s) 580, portable storage device 540, and graphics display 570 may be connected via one or more input/output (I/O) buses.

Mass storage device 530, which may be implemented with a magnetic disk drive or an optical disk drive, is a non-volatile storage device for storing data and instructions for use by processor 510. Mass storage device 530 may store the system software for implementing embodiments of the present invention for purposes of loading that software into memory 520.

Portable storage device 540 operates in conjunction with a portable non-volatile storage medium, such as a floppy disk, compact disk, digital video disc, or USB storage device, to input and output data and code to and from the system. The system software for implementing embodiments of the present invention may be stored on such a portable medium and input to the system 500 via the portable storage device 540.

User input devices 560 provide a portion of a user interface. User input devices 560 may include one or more microphones, an alphanumeric keypad, such as a keyboard, for inputting alpha-numeric and other information, or a pointing device, such as a mouse, a trackball, stylus, or cursor direction keys. User input devices 560 may also include a touchscreen. Additionally, the system 500 as shown in FIG. 5 includes output devices 550. Suitable output devices include speakers, printers, network interfaces, and monitors.

Graphics display 570 may include a liquid crystal display (LCD) or other suitable display device. Graphics display 570 receives textual and graphical information, and processes the information for output to the display device.

Peripheral devices 580 may be included and may include any type of computer support device to add additional functionality to the computer system.

The components provided in the system 500 are those typically found in computer systems that may be suitable for use with embodiments of the present invention and are intended to represent a broad category of such computer components that are well known in the art. Thus, the system 500 may be a personal computer, hand-held computing system, telephone, mobile computing system, workstation, server, minicomputer, mainframe computer, or any other computing system. The computer may also include different bus configurations, networked platforms, multi-processor platforms, etc. Various operating systems may be used including Unix, Linux, Windows, Mac OS, Palm OS, Android, IOS (known as iPhone OS before June 2010), QNX, and other suitable operating systems.

It is noteworthy that any hardware platform suitable for performing the processing described herein is suitable for use with the embodiments provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), Blu-ray Disc (BD), any other optical storage medium, RAM, PROM, EPROM, EEPROM, FLASH memory, and/or any other memory chip, module, or cartridge.

The above description is illustrative and not restrictive. Many variations of the technology will become apparent to those of skill in the art upon review of this disclosure. The scope of the technology should, therefore, be determined not with reference to the above description, but instead should be determined with reference to the appended claims along with their full scope of equivalents.

1. A carbon accounting system, comprising:
a data receiving arrangement configured to receive energy data from an energy data collection apparatus,
a data aggregation processor configured to aggregate the energy data with other energy data to form aggregated energy data; and
a data communicator configured to transfer the aggregated energy data to a blockchain platform, the blockchain platform configured to share the aggregated energy data and perform carbon accounting on a blockchain.

2. The carbon accounting system of claim 1, wherein the carbon accounting comprises calculating carbon emissions.

3. The carbon accounting system of claim 1, wherein the energy data collection apparatus is configured to collect the energy data in real-time.

4. The carbon accounting system of claim 1, wherein the energy data collection apparatus comprises a smart meter.

5. The carbon accounting system of claim 1, wherein the blockchain platform is configured to automatically convert Renewable Energy Credits (RECs) into Non-Fungible Tokens (NFTs).

6. The carbon accounting system of claim 1, wherein the aggregated energy data is formatted in a standardized form.

7. A method of accounting for carbon emissions, comprising:
receiving energy data from an energy data collection apparatus;
aggregating, using a data aggregation processor, the energy data with other energy data to form aggregated energy data;
transferring the aggregated energy data to a blockchain platform, the blockchain platform configured to share the aggregated energy data; and
performing carbon accounting on a blockchain.

8. The method of claim 7, wherein the carbon accounting comprises calculating carbon emissions.

9. The method of claim 7, wherein the energy data collection apparatus is configured to collect the energy data in real-time.

10. The method of claim 7, wherein the energy data collection apparatus comprises a smart meter.

11. The method of claim 7, wherein the blockchain platform is configured to automatically convert Renewable Energy Credits (RECs) into Non-Fungible Tokens (NFTs).

12. The method of claim 7, wherein the aggregated energy data is formatted in a standardized form.
